SEQUENCE LISTING (17 sequences)

SEQ ID NO: 1 - DNA, 50 bp, Artificial
  Exemplary Sequence 901
aagggtacttgatgcgcgaaggctaagaagttcgtatctgtgacaaatat

SEQ ID NO: 2 - DNA, 50 bp, Artificial
  Exemplary Sequence 905
agcaggggcgcccctagtggggccagtaaactactttttagctatggtat

SEQ ID NO: 3 - DNA, 79 bp, Artificial
  Reference Sequence
cattccgcccttgccagcccagagccttttgcagtttatctctatgcccgggacaagtggacagatggataataagttc

SEQ ID NO: 4 - DNA, 53 bp, Artificial
  Derived from Reference Sequence
cattccgcccttgccagcccagagccttttgcagtttatctatgcccgggacc

SEQ ID NO: 5 - DNA, 53 bp, Artificial
  Derived from Reference Sequence
cattccgcccttgccagcccagagccttttgcagtatgcccgggacaagtggg

SEQ ID NO: 6 - DNA, 53 bp, Artificial
  Derived from Reference Sequence
cattccgcccttgccagcccagagccttttgcagttatgcccgggacaagtgg

SEQ ID NO: 7 - DNA, 53 bp, Artificial
  Derived from Reference Sequence
cattccgcccttgccagcccagagccttttgcagtttattatgcccgggacaa

SEQ ID NO: 8 - DNA, 53 bp, Artificial
  Derived from Reference Sequence
cattccgcccttgccagcccagagccttttgcagttttatgcccgggacaagg

SEQ ID NO: 9 - DNA, 53 bp, Artificial
  Derived from Reference Sequence
cattccgcccttgccagcccagagccttttgcagttctatgcccgggacaagg

SEQ ID NO: 10 - DNA, 53 bp, Artificial
  Derived from Reference Sequence
cattccgcccttgccagcccagagccttttgcagcccgggacaagtggacagg

SEQ ID NO: 11 - DNA, 53 bp, Artificial
  Derived from Reference Sequence
cattccgcccttgccagcccagagccttttgcagtttatgcccgggacaagtt

SEQ ID NO: 12 - DNA, 53 bp, Artificial
  Derived from Reference Sequence
cattccgcccttgccagcccagagccttttgcagtttctctatgcccgggacc

SEQ ID NO: 13 - DNA, 53 bp, Artificial
  Derived from Reference Sequence
cattccgcccttgccagcccagagcctatgcccgggacaagtggacagatggg

SEQ ID NO: 14 - DNA, 53 bp, Artificial
  Derived from Reference Sequence
cattccgcccttgccagcccagagccttttgcagtccgggacaagtggacagg

SEQ ID NO: 15 - DNA, 53 bp, Artificial
  Derived from Reference Sequence
cattccgcccttgccagcccagagccttttgcagtttctatgcccgggacaaa

SEQ ID NO: 16 - DNA, 53 bp, Artificial
  Derived from Reference Sequence
cattccgcccttgccagcccagagccttttgcagctatgcccgggacaagtgg

SEQ ID NO: 17 - DNA, 53 bp, Artificial
  Derived from Reference Sequence
cattccgcccttgccagcccagagccttttgcagtttatatgcccgggacaaa

(19) United States
(12) Patent Application Publication
(10) Pub. No.: US 2012/0173153 A1
(43) Pub. Date: Jul. 5, 2012

(54) DATA ANALYSIS OF DNA SEQUENCES

(75) Inventors: Navin Elango, Indianapolis, IN (US); Joseph F. Petolino, Zionsville, IN (US); Shreedharan Sriram, Indianapolis, IN (US); Lakshmi Sastry-Dent, Indianapolis, IN (US)

(73) Assignee: DOW AGROSCIENCES LLC, Indianapolis, IN (US)

(21) Appl. No.: 13/332,242

(22) Filed: Dec. 20, 2011

Related U.S. Application Data
(60) Provisional application No. 61/428,191, filed on Dec. 29, 2010.
(60) Provisional application No. 61/503,784, filed on Jul. 1, 2011.

(51) Int. Cl. G06F 19/22

(52) U.S. Cl. 702/19

(57) ABSTRACT

Systems and methods for data analysis are provided. In one embodiment, a method may be provided for analysis comprising electronically receiving sequence data related to a plurality of sequences and a reference sequence, associating the sequence data with one of at least two groups, identifying a plurality of high quality read sequences from among the plurality of sequences, extracting a plurality of unique read sequences from the plurality of high quality read sequences, and aligning the plurality of unique read sequences against the reference sequence data corresponding to a reference sample. The method may further identify mutations in a targeted location, display the targeted mutations, and prioritize the technologies that caused the mutations according to their efficiency. In one example, the systems and methods are used to characterize the activity of several ZFN candidates.

### CROSS REFERENCE TO RELATED APPLICATIONS

This application claims priority to U.S. Provisional Patent Application 61/428,191, filed Dec. 29, 2010, and U.S. Provisional Patent Application 61/503,784, filed Jul. 1, 2011, the entire disclosures of which are incorporated by reference.

### BACKGROUND

Zinc finger nucleases (ZFN) are enzymes that can be engineered to cut DNA strands at specific sequences in the genome to generate double strand breaks. One process by which double strand breaks are repaired is non-homologous end joining (NHEJ). NHEJ mediated repair results in addition and/or deletion of random base pairs at the ZFN cleavage site, creating ZFN induced genome modifications. The modifications may create a differently coded strand of DNA that may be used for biological analysis. The analysis of ZFN induced genome modifications may indicate the relative efficacy of a specific ZFN at a specific cleavage location/site in a genome.

Various tools can be used to cut or modify a sequence of DNA. For example, EXZACT Precision Technology brand equipment, available from Dow Agrosciences located at 9330 Zionsville Road in Indianapolis, Ind. 46268, is a cutting-edge, versatile and robust toolkit for genome modification. It is based on the design and use of ZFNs.

The rapid development of new sequencing technologies substantially extends the scale and resolution of many biological applications including the scan of genome wide variations, assembly of new genomes and transcriptomics studies. All next generation sequencing (NGS) platforms in production, including the Roche 454 brand sequencing platform available from Roche Diagnostics Corp., ILLUMINA and/or SOLEXA brand sequencing platforms available from Illumina, Inc., and SOLID brand sequencing platform available from Applied Biosystems, are able to produce data of the order of giga base pairs (Gbp) per machine day. The Roche 454 brand sequencing platform produces long ‘read’ sequences while Illumina (Solexa) and SOLiD brand sequencers are short read sequencing platforms (typically ˜36-100 bp). Next generation sequencing (NGS) technology allows for the generation of a large amount of sequencing data, offers a high level of sensitivity of detection and allows for a large number of samples to be analyzed.

### SUMMARY

In an exemplary embodiment of the present disclosure, an analysis system and computational method is presented to quantify the targeting activity of zinc finger nucleases. Systems and methods are provided that may be used to screen and rank large numbers of ZFNs at their specific targets in a particular genomic system. The systems and methods may be used to validate any genomic modification (exemplary genomic modifications include nucleotide insertions/deletions, gene additions, point mutations, and methylation) performed using any technology (exemplary technologies include protein or small molecule directed or combinations of both or physical methods). Additionally, the systems and methods can be further modified to accommodate translational scripts that allow functional read out of the genome modifications (i.e. protein products of the modified genomes).

In an exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample.

In another exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample. The method further comprising, after aligning the plurality of unique read sequences against the reference sequence data corresponding to the reference sample, calculating high quality alignments.

In yet another exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample. The method further comprising conducting a qualitative analysis of the aligned unique read sequences.

In still another exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample. The method further comprising a quantitative analysis of the aligned unique read sequences.

In yet still another exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample. The method further comprising visualizing the aligned unique read sequences.

In a further exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample. The method further comprising calculating the alignment between each of the plurality of unique read sequences to the reference sequence.

In yet a further exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample. The method further comprising electronically receiving confidence interval data related to the sequence data, the confidence interval data used at least in part to identify the plurality of high quality read sequences.

In still a further exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample, wherein each of the plurality of sequences describes at least a portion of a plant genome.

In yet still a further exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample, wherein barcode information describing one or more barcodes is electronically received associated with the sequence data.

In still yet a further exemplary embodiment of the present disclosure, a method for analysis is provided. The method comprising: electronically receiving sequence data related to a plurality of sequences; identifying a plurality of hi_{g}h _{q}uality read sequences from among the plurality of sequences; extracting a plurality of unique read sequences from the plurality of high quality read sequences; and comparing the plurality of unique read sequences against a reference sequence corresponding to a reference sample, wherein barcode information describing one or more barcodes is electronically received associated with the sequence data and associating the sequence data with one of at least two groups comprises reading the barcode information associated with the sequence data, and associating the sequence data according to the one or more barcodes.

In still yet a further exemplary embodiment of the present disclosure, a method for analysis is provided. The method comprising: electronically receiving sequence data related to a plurality of sequences; identifying a plurality of high quality read sequences from among the plurality of sequences; extracting a plurality of unique read sequences from the plurality of high quality read sequences; and comparing the plurality of unique read sequences against a reference sequence corresponding to a reference sample. The method further comprising associating the sequence data with one of at least two groups.

In another exemplary embodiment of the present disclosure, a system for analysis is provided. The system comprising: a module for receiving sequence data related to a plurality of sequences; and a calculation module. The calculation module operable to: identify a plurality of high quality read sequences from among the plurality of sequences; extract a plurality of unique read sequences from the plurality of high quality read sequences; and compare the plurality of unique read sequences relative to a reference sequence corresponding to a reference sample.

In yet another exemplary embodiment of the present disclosure, a system for analysis is provided. The system comprising: a module for receiving sequence data related to a plurality of sequences; and a calculation module. The calculation module operable to: identify a plurality of high quality read sequences from among the plurality of sequences; extract a plurality of unique read sequences from the plurality of high quality read sequences; and compare the plurality of unique read sequences relative to a reference sequence corresponding to a reference sample, wherein the calculation module is further operable to calculate high quality alignments from the plurality of high quality read sequences.

In still another exemplary embodiment of the present disclosure, a system for analysis is provided. The system comprising: a module for receiving sequence data related to a plurality of sequences; and a calculation module. The calculation module operable to: identify a plurality of high quality read sequences from among the plurality of sequences; extract a plurality of unique read sequences from the plurality of high quality read sequences; and compare the plurality of unique read sequences relative to a reference sequence corresponding to a reference sample. The system further comprising a module to conduct a qualitative analysis of the aligned unique read sequences.

In still yet another exemplary embodiment of the present disclosure, a system for analysis is provided. The system comprising: a module for receiving sequence data related to a plurality of sequences; and a calculation module. The calculation module operable to: identify a plurality of high quality read sequences from among the plurality of sequences; extract a plurality of unique read sequences from the plurality of high quality read sequences; and compare the plurality of unique read sequences relative to a reference sequence corresponding to a reference sample. The system further comprising a module to conduct a quantitative analysis of the aligned unique read sequences.

In yet still another exemplary embodiment of the present disclosure, a system for analysis is provided. The system comprising: a module for receiving sequence data related to a plurality of sequences; and a calculation module. The calculation module operable to: identify a plurality of high quality read sequences from among the plurality of sequences; extract a plurality of unique read sequences from the plurality of high quality read sequences; and compare the plurality of unique read sequences relative to a reference sequence corresponding to a reference sample. The system further comprising a module to visualize the aligned unique read sequences.

In a further exemplary embodiment of the present disclosure, a system for analysis is provided. The system comprising: a module for receiving sequence data related to a plurality of sequences; and a calculation module. The calculation module operable to: identify a plurality of high quality read sequences from among the plurality of sequences; extract a plurality of unique read sequences from the plurality of high quality read sequences; and compare the plurality of unique read sequences relative to a reference sequence corresponding to a reference sample, wherein the calculation module is further operable to calculate the alignment between each of the plurality of high quality alignments to the reference sequence.

In a further exemplary embodiment of the present disclosure, a system for analysis is provided. The system comprising: a module for receiving sequence data related to a plurality of sequences; and a calculation module. The calculation module operable to: identify a plurality of high quality read sequences from among the plurality of sequences; extract a plurality of unique read sequences from the plurality of high quality read sequences; and compare the plurality of unique read sequences relative to a reference sequence corresponding to a reference sample, wherein the calculation module further associates the sequence data with one of at least two groups.

In another exemplary embodiment of the present disclosure, a method for analysis is provided. The method comprising: electronically receiving sequence data regarding a plurality of sequences, the plurality of sequences describing at least a portion of a plant genome, the plurality of sequences having been previously exposed to one or more zinc finger nucleases to cut the sequences; electronically receiving confidence interval data related to the sequence data; identifying a plurality of high quality read sequences from among the plurality of sequences based at least in part on the confidence interval data; extracting unique read sequences from the one or more high quality read sequences; and aligning the unique read sequences against the sequence data corresponding to the reference sample.

In another exemplary embodiment of the present disclosure, a method for analysis is provided. The method comprising: electronically receiving sequence data regarding a plurality of sequences, the plurality of sequences describing at least a portion of a plant genome, the plurality of sequences having been previously exposed to one or more zinc finger nucleases to cut the sequences; electronically receiving confidence interval data related to the sequence data; identifying a plurality of high quality read sequences from among the plurality of sequences based at least in part on the confidence interval data; extracting unique read sequences from the one or more high quality read sequences; and aligning the unique read sequences against the sequence data corresponding to the reference sample. The method further comprising the steps of: electronically receiving barcode information associated with the sequence data; and associating the sequence data with one of a least two groups based at least in part on the barcode information.

In a further exemplary embodiment of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being at least two orders of magnitude less than the first number of sequences.

In yet a further exemplary embodiment of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being at least two orders of magnitude less than the first number of sequences, wherein the second number of sequences is at least four orders of magnitude less than the first number of sequences.

In still a further exemplary embodiment of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being at least two orders of magnitude less than the first number of sequences, wherein a first characteristic of repair to the sequence includes a measure of at least one of a number of insertions in a target cut region and a number of deletions.

In yet still a further exemplary embodiment of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being at least two orders of magnitude less than the first number of sequences, wherein the step of electronically determining, based in part on the reference sequence, the second number of sequences includes the steps of: separating the first number of sequences into a plurality of groups based on the ZFN used to cut the respective sequence; identifying a plurality of high quality read sequences in the first number of sequences, the plurality of high quality read sequences having a third number of sequences which is less than the first number of sequences and greater than the second number of sequences, identifying a plurality of unique read sequences from the third number of sequences, the plurality of unique read sequences having a fourth number of sequences which is less than the third number of sequences and greater or lesser than the second number of sequences, and comparing each of the fourth number of sequences relative to the reference sequence to identify a plurality of high quality alignment sequences.

In a further exemplary embodiment of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being less than 1 percent of the first number of sequences.

In yet a further exemplary embodiment of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being less than 1 percent of the first number of sequences, wherein the second number of sequences is less than 0.1 percent of the first number of sequences.

In still a further exemplary embodiment of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being less than 1 percent of the first number of sequences, wherein the second number of sequences is less than 0.01 percent of the first number of sequences.

In still yet a further exemplary embodimenf of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being less than. 1 percent of the first number of sequences, wherein the second number of sequences is less than 0.01 percent of the first number of sequences and the first number of sequences is at least one million sequences.

In yet still another exemplary embodiment of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being less than 1 percent of the first number of sequences, wherein a first characteristic of repair to the sequence includes a measure of at least one of a number of insertions in a target cut region and a number of deletions.

In still a further exemplary embodiment of the present disclosure, a method for analysis is provided. The method comprising: electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being less than 1 percent of the first number of sequences, wherein the step of electronically determining, based in part on the reference sequence, the second number of sequences includes the steps of: separating the first number of sequences into a plurality of groups based on the ZFN used to cut the respective sequence; identifying a plurality of high quality read sequences in the first number of sequences, the plurality of high quality read sequences having a third number of sequences which is less than the first number of sequences and greater than the second number of sequences, identifying a plurality of unique read sequences from the third number of sequences, the plurality of unique read sequences having a fourth number of sequences which is less than the third number of sequences and greater or lesser than the second number of sequences, and comparing each of the fourth number of sequences relative to the reference sequence to identify a plurality of high quality alignment sequences.

### BRIEF DESCRIPTION OF THE DRAWINGS

The detailed description of the drawings particularly refers to the accompanying figures in which:

FIG. 1 is a flow chart showing a method of data analysis according to an embodiment of the present disclosure;

FIG. 2 is a flow chart showing the pre-processing of data from FIG. 1 according to an embodiment of the present disclosure;

FIG. 3 is a flow chart showing the alignment of data from FIG. 1 according to an embodiment of the present disclosure;

FIG. 4 is a flow chart showing the post-processing of data from FIG. 1 according to an embodiment of the present disclosure;

FIG. 5 is a flow chart of data and materials from a sequencer to a data analyzer according to an embodiment of the present disclosure;

FIG. 6 is a system diagram of a data analyzer according to an embodiment of the present disclosure;

FIG. 7 is a an exemplary set of sequences with barcodes according to an embodiment of the present disclosure;

FIG. 8A is a chart of the exemplary set of sequences of FIG. 7, organizing the sequences according to barcode, according to an embodiment of the present disclosure;

FIG. 8B is a chart of the exemplary set of sequences of FIG. 7, organizing the sequences according to unique sequences, according to an embodiment of the present disclosure;

FIG. 8C is a chart of the exemplary set of sequences of FIG. 8B, with a count of the number of sequences associated with each unique sequence;

FIG. 9 is an exemplary set of two sequences containing confidence intervals for each base according to an embodiment of the present disclosure;

FIG. 10 is an exemplary visualization of a number of sequences according to an embodiment of the present disclosure;

FIG. 11 is an exemplary set of comparisons between total reads from a sequencer, and the number of high quality reads obtained after one or more filters was applied to the total reads according to an embodiment of the present disclosure;

FIG. 12 is an exemplary quantitative analysis of several ZFNs according to an embodiment of the present disclosure;

FIG. 13 is an exemplary set of graphs detailing ZFN activity according to an embodiment of the present disclosure; and

FIG. 14 is an exemplary set of graphs detailing ZFN activity according to an embodiment of the present disclosure.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific configurations of an analysis system, it should be understood that the concepts presented herein may be used in other various configurations consistent with this disclosure. Further, although the analysis of DNA sequences which were exposed to ZFNs are discussed, the teachings herein may be applied to the analysis of other sequences exposed to ZFNs or other enzymes.

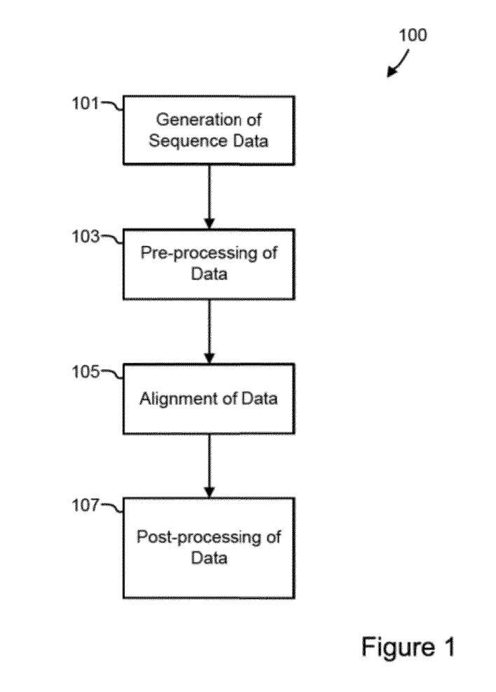

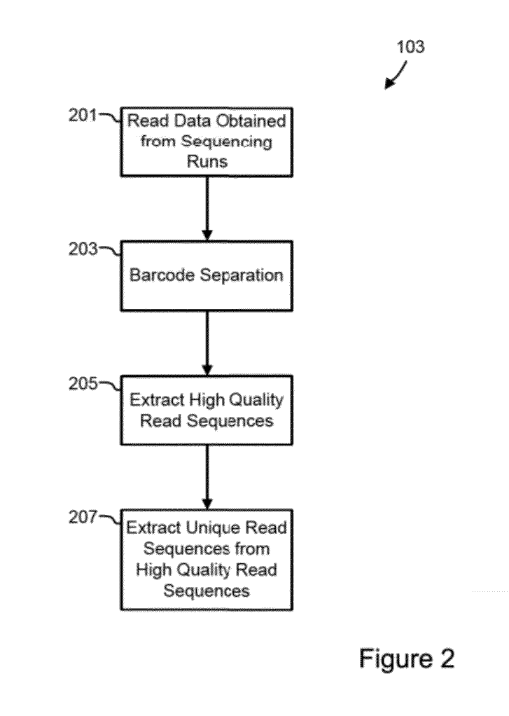

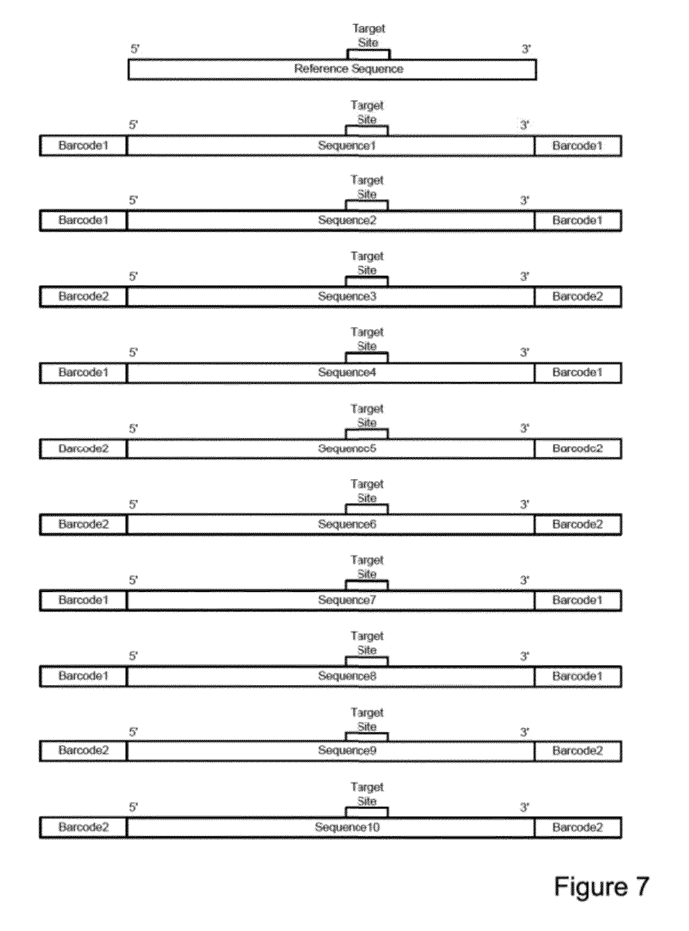

FIG. 1 shows a flow chart showing a method of data analysis according to an embodiment of the present disclosure. One or more sequencers generate sequence data from one or more samples, as illustrated in box 101. The data collected from the sequencer is pre-processed to organize the available data and reduce the overall amount of data to be analyzed, illustrated in box 103. Sequences are aligned against a reference sample and analyzed, illustrated in box 105. The sequence data from the aligned sequences are separated and efficacy of each of the ZFNs may be quantitatively and qualitatively analyzed in post-processing, as illustrated in box 107. The method is described with reference to FIGS. 2-4, and an exemplary set of sequences to illustratively show pre-processing is shown with respect to FIGS. 7-9.

Samples to be analyzed may be prepared by adding a quantity of a ZFN to a sample containing one or more cells/tissues from the organism of interest. The one or more cells contain genomic DNA which includes a specific cleavage site targeted by the ZFN. A ZFN molecule may cut one or more of the DNA strands at a specific cleavage site. The DNA may be repaired by one or more other enzymes, and the repair of the DNA may include one or more random modifications at the cleavage site. In some cases, the DNA strand may be repaired so that the sequence is exactly like the sequence of the DNA strand before the cut. In other cases, the DNA strand may include one or more additional bases, or the DNA strand may have one or more bases removed. Additionally, one or more samples may be prepared that include only one or more cells/tissues from the organism of interest without the addition of a ZFN. A sample without a ZFN is referred to as a control sample. In general, multiple samples are prepared, each having a unique ZFN treatment. Two or more samples may include the same ZFN for replicate treatment. By analyzing the effect of each ZFN, one or more ZFNs of interest for a given genomic DNA may be identified.

In samples where a common DNA strand and a common ZFN are used, a unique identification marker or barcode is added to the DNA strand. In one embodiment, the barcode is a series of, for example, six nucleotides at the 5′ end of the DNA strand, and six nucleotides at the 3′ end of the DNA strand. In an embodiment, the barcode may be more or less than six nucleotides at each end. In an embodiment, the barcode may be at the 5′ end of the DNA strand only or at the 3′ end of the DNA strand only and include one of six nucleotides, less than six nucleotides, or more than six nucleotides. More or fewer nucleotides may be used as a barcode. The barcode allows for DNA strands of a plurality of samples to be analyzed in a single run of the sequencer. The sample from which each of the plurality of sequences originated can be recognized by the sequencer due to the presence of the barcode. The sequences can be separated by barcode after sequencing, and may be separated according to the added zinc finger nuclease during processing and analysis. In one embodiment, at least one barcode is added to the control DNA strands that have not been treated with a ZFN.

The samples are loaded into a sequencer according to a protocol or operating instructions of the sequencer. For example, a Solexa ILLUMINA brand sequencing machine or a Roche 454 brand sequencing machine may be used. The sequencer generates data related to the sequences. The data may include, but is not limited to, one or more text files or other data files containing information related to the sequences of the DNA strands in the samples. In an embodiment, the sequence information also includes confidence data, so that each base in a sequence may have a confidence interval associated with it, or each sequence has a confidence interval associated with it. The confidence interval is a mathematical calculation calculated by the sequencer, and may include the strength of the read of the particular base by the sequencer. In one illustrative example, the confidence interval is an integer from one to nine. In the example, a confidence interval of one indicates that the sequencer has relatively low confidence that the base reported was the base in the DNA strand. A confidence interval of nine indicates that the sequencer has relatively high confidence that the base reported was the base in the DNA strand. In an embodiment, the sequencer also reports other information in addition to the confidence interval. For example, the sequencer may report when a base could not be read.

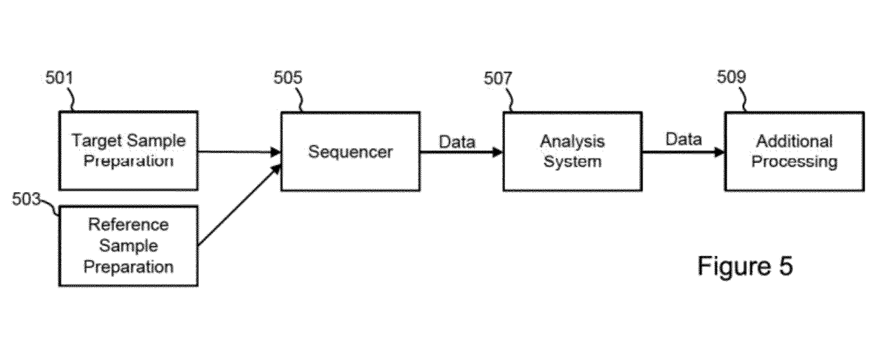

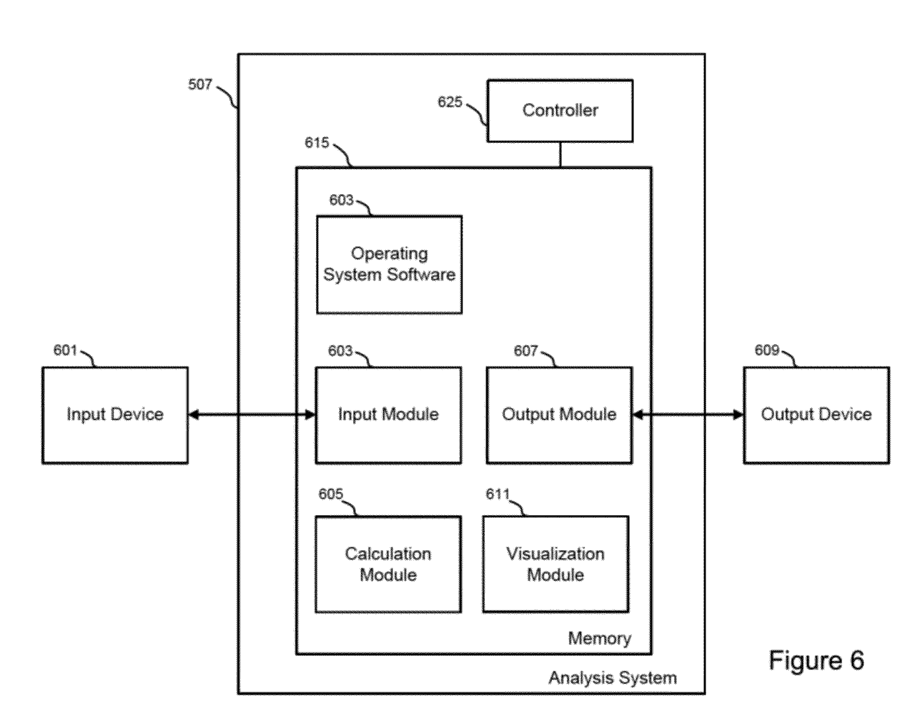

Turning now to FIG. 2, a flow chart showing the pre-processing of data from FIG. 1 according to an embodiment of the present disclosure is shown. The data for the sequencing runs is read from the sequencer, as illustrated in box 201. In an embodiment, the data is in the form of one or more text files, the text files containing the sequence information and other data regarding the sequencer and/or the data set. The data includes short DNA sequences, or “reads.” In an embodiment, the data also includes confidence interval scores for each of the bases read by the sequencer in each of the reads. The barcode data is read by an analysis system 507, as described in more detail below with reference to FIGS. 5 and 6, and the reads are separated by barcode, if the samples have been coded with a barcode, so that reads with the same barcode are placed together. In an embodiment, information about the barcodes is stored in a database, a spreadsheet, or other data file or files, and the barcode information and the information about the barcodes is made available to the analysis system 507.

An exemplary set of sequences with barcodes is shown in FIG. 7. Each of the sequences has a target site, and a 5′ end and a 3′ end. In the illustrative example, the barcodes are attached to both the 5′ and the 3′ ends of the sequence. In an embodiment, the barcodes may be attached to the 5′ end of the sequence only, or the 3′ end of the sequence only. In FIG. 7, two barcodes are present, barcode1 and barcode2. Each of the sequences is associated with one of the barcodes, so that Sequence1, Sequence2, Sequence4, Sequence7, and Sequence8 each have barcode1, and Sequence3, Sequence5, Sequence6, Sequence9, and Sequence 10 each have barcode2. In one embodiment, all sequences treated with a first ZFN have barcodel while all sequences treated with a second ZFN have barcode2. In one embodiment, the DNA strands corresponding to the sequences are placed in a sample collection chamber in the sequencer. In another embodiment, the DNA strands are combined 3′ end to 5′ end (with the appropriate barcode) to form a continuous strand of DNA, and the continuous strand is placed in a sample collection chamber in the sequencer. In this embodiment, the sequencer and/or the analysis system 507 separates the sequences after sequencing.

The reads having the same barcode are placed together, as illustrated in box 203 of FIG. 2. The analysis system 507, or other pre-processing system, removes the barcode information from the reads, so the DNA sequence information for the reads remains for analysis.

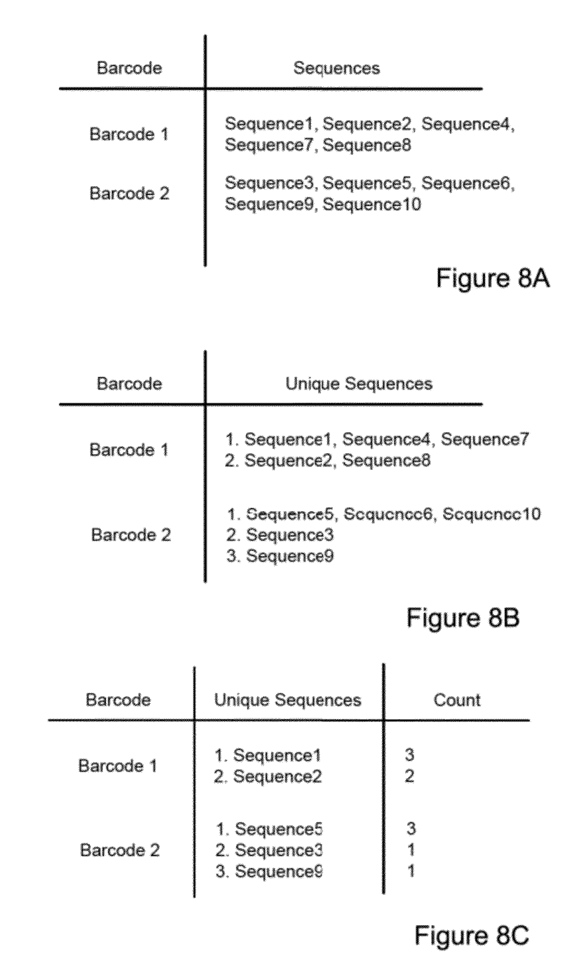

The exemplary set of sequences of FIG. 7, organized according to barcode, is shown in FIG. 8A. Sequence1, Sequence2, Sequence4, Sequence7, and Sequence8 are separated from Sequence3, Sequence5, Sequence6, Sequence9, and Sequence10. The sequences are grouped by barcode, and then the barcodes are removed from the sequences. In one embodiment, sequences are stored in memory, and are grouped by barcode.

The sequence data for the reads is reviewed, as illustrated in box 205 of FIG. 2. The number of sequences is reduced by removing low quality reads from further consideration.

In one embodiment, whether a sequence is considered a low quality read is based on the confidence interval information associated with the sequence data. The confidence interval information for each of the bases is reviewed, if confidence interval information is provided by the sequencer or can be calculated. In one embodiment, a read with one or more bases that fall below a confidence interval value is rejected as a low quality read. A read where all of the bases are above a confidence interval value is accepted as a high quality read. For a sequencer with confidence intervals between zero and 100, with zero being a low confidence interval and 100 being a high confidence interval, and a threshold confidence interval value of 30, an exemplary read with confidence intervals of 65, 50, 40, and 70 is accepted as a high quality read, as each of the confidence intervals is above 30. Another exemplary read with confidence intervals of 25, 10, 90, and 56 is rejected as a low quality read, as at least one of the confidence intervals fell below 30. Other forms of analysis may also be used to determine one or more selection criteria. For example, an average of the confidence intervals for each base in a read may be averaged, and the read may be rejected if the average confidence interval is below a threshold confidence interval value. In an embodiment, the confidence interval is set by a protocol, or set by the user through an input device 601 of analysis system 507. The user may also adjust the confidence interval value if too many reads are rejected, or if too many reads are accepted, as judged by the user or a protocol. The analysis system 507 may also adjust the confidence interval without further user input if too many reads are rejected, or if too many reads are accepted.

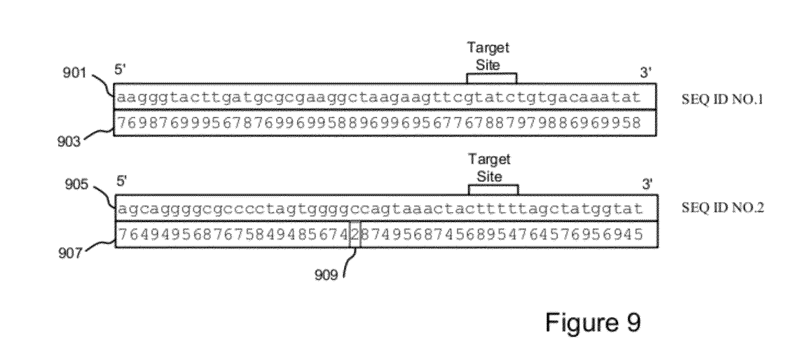

FIG. 9 shows an exemplary set of two sequences 901, 905 containing confidence intervals. The first sequence 901 contains 50 bases, and a confidence interval 903 of between 1 and 9 associated with each of the bases. The confidence intervals are assigned by the sequencer, and indicate the relative confidence of the sequencer that the particular base is correctly identified. A confidence interval of 9 in the example indicates that the sequencer is highly confident that the base is correctly identified. A confidence interval of 1 in the example indicates that the sequencer is not confident that the base is correctly identified. In the example, the threshold confidence interval value is set at 4, meaning that a sequence with any base confidence interval lower than 4 is rejected. The analysis system 507 may review both the first exemplary sequence 901 and the second exemplary sequence 905. The first exemplary sequence 901 contains confidence intervals 903 for each base that are 5 or higher, so the analysis system 507 accepts the first sequence 901 for further processing. The confidence intervals 907 associated with the second exemplary sequence 905 indicate one confidence interval 909 having a value of 2, so the analysis system 507 rejects the second exemplary sequence. In an embodiment, the average confidence interval is determined from the series of confidence intervals associated with the bases of a particular sequence. If the average confidence interval is, for example, below a confidence interval value, then the sequence is rejected. In another embodiment, a sequence must have two or more confidence intervals below the confidence interval value to be rejected. The analysis system may determine which sequences to accept or reject based on the confidence intervals of the entire sequence, or may determine which sequences to accept or reject based on a subset of the entire sequence. For example, the analysis system may review the confidence intervals for the target site of the sequence, or one or more bases adjacent to the target site.

Low quality reads, as determined by their confidence interval, may be removed by the analysis system 507, and may not be considered further. High quality reads, as determined by their confidence interval, may be accepted by the analysis system 507 for further processing. The high quality reads remain separated by barcode. In one embodiment, the reads are determined to be low quality or high quality prior to separation by barcode.

Unique read sequences are extracted from the high quality reads, as illustrated in box 207. The analysis system 507 reviews the reads for a given barcode, compares the reads to one another, and extracts the reads that are unique. In an embodiment, the analysis system 507 also counts the number of reads that are identical to the unique sequences, and weights further analysis based on the number of reads that are identical to a particular unique sequence.

FIG. 8B shows the sequences of FIG. 7 and FIG. 8A sorted into unique sequences. Within the sequences associated with barcodel, Sequence1, Sequence4, and Sequence7 are unique, and Sequence2 and Sequence8 are unique. Within the sequences associated with barcode2, Sequence3, Sequence6, and Sequence10 are identical, Sequence3 is unique, and Sequence9 is unique.

FIG. 8C shows a chart of the exemplary set of sequences of FIG. 8B, with a count of the number of sequences associated with each unique sequence. In the example, the unique sequences are identified by the identifier of the first sequence in the set of unique sequences shown in FIG. 8B. Associated with barcodel, the unique sequence identified by Sequence1 has three identical sequences (Sequence1, Sequence4, and Sequence7), and the unique sequence identified as Sequence2 has two identical sequences (Sequence2 and Sequence8). Associated with barcode2, the unique sequence identified by Sequence5 has three identical sequences (Sequence5, Sequence6, and Sequence 10), the unique sequence identified by Sequence3 is unique, and the unique sequence identified by Sequence9 is unique.

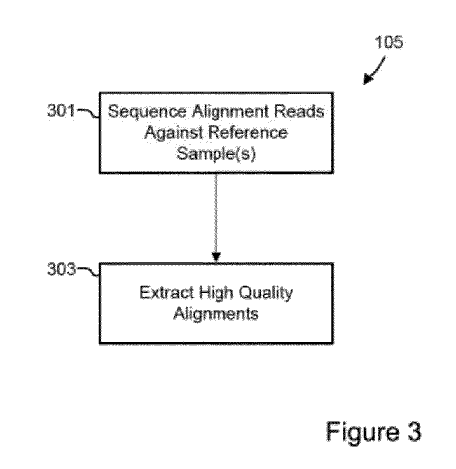

Turning now to FIG. 3, a flow chart showing the alignment of data from FIG. 1 according to an embodiment of the present disclosure is shown. Reads are aligned to the sequence of a reference sample (not treated with a ZFN) to determine the changes that the repair mechanism made to the read, if any, as illustrated in box 301.

In one embodiment, the analysis system 507 uses a Smith-Waterman algorithm to align the read to the sequence of the reference sample. In an embodiment, the Smith-Waterman algorithm may be modified or customized to increase performance or make other modifications. In an embodiment, the JAligner open source software package may be used, or a modified version of the JAligner software package that implements the Smith-Waterman algorithm may be used to align the reads to the sequence of the reference sample.

The Smith-Waterman algorithm is a dynamic programming method for determining similarity between nucleotide or protein sequences. The algorithm is used for identifying homologous regions between sequences by searching for optimal local alignments. To find the optimal local alignment, a scoring system including a set of specified gap penalties is used. The Smith-Waterman algorithm is built on the idea of comparing segments ofiall possible lengths between two sequences to identify the best local alignment. The algorithm is based on dynamic programming which is a general technique used for dividing problems into sub-problems and solving these sub-problems before putting the solutions to each small piece of the problem together for a complete solution covering the entire problem. Implementing the technique of dynamic programming, the Smith-Waterman algorithm finds the optimal local alignment considering alignments of any possible length starting and ending at any position in the two sequences being compared.

Sequence alignments generally fall within one of four categories. In the first category, the read and the reference sample sequence match exactly. The read and the reference sample sequence match exactly under two conditions. First, the ZFN, was not active at that particular read (i.e., the ZFN did not cut the DNA strand). Second, the ZFN cut the DNA strand, but the repair mechanism perfectly repaired the strand, so that the repaired strand was exactly the same as the reference sample sequence.

In the second category, the read aligns with the reference sample sequence, if one or more bases is changed or mutated from the reference sample sequence. The mutated bases may be either within the target site, or outside of the target site. If the mutated bases are inside of the target site, then the ZFN may have cut the DNA strand at the,target site, and the repair mechanism may have repaired the DNA strand with the addition of random bases. If the mutated bases are outside of the target site, then the repair mechanism may have incorrectly repaired the DNA strand, or the sequencer may have incorrectly read the DNA strand, or the ZFN may have cut the DNA strand at a position other than the target site. In an embodiment, if the mutated bases are inside of the target site, the read is retained. If the mutated bases are outside of the target site, then the read is rejected.

In the third category, the read aligns with the reference sample sequence if one or more bases are inserted (i.e., one or more bases must be inserted so that the read aligns with the reference sample sequence).

In the fourth category, the read aligns with the reference sample sequence if one or more bases are deleted from the read (i.e., one or more bases must be deleted so that the read aligns with the reference sample sequence).

In one embodiment, reads are evaluated to be in one of the above four categories. In an embodiment, if the read is in the first category, it is removed from further consideration. If the read is in the second category, it is removed from further consideration. Reads that fall into the third or fourth categories are further considered.

The alignment algorithm may be modified to include parameter optimization, development of a specific scoring criteria, and manipulation of the output alignment format, so that the format is compatible with other visualization or analysis programs or algorithms. The parameter values, for example, are used to “score” a read to determine if the read is high quality or low quality. Parameter values that may be used with the modified algorithm include: Match score—3, mismatch score—0, Gap open penalty—2, and Gap extension penalty—1. Each base may be assigned a score, and the read may be accepted for further processing or rejected depending on the aggregate score of each of the bases, or of an average score.

The algorithm assigns a score to each residue comparison between two sequences. By assigning scores for matches or substitutions and insertions/deletions, the comparison of each pair of characters is weighted into a matrix by calculation of every possible path for a given cell. In any matrix cell, the value represents the score of the optimal alignment ending at these coordinates, and the matrix reports the highest scoring alignment as the optimal alignment. For constructing the optimal local alignment from the matrix, the starting point is the highest scoring matrix cell. The path is then traced back through the array until a cell scoring zero is met. Because the score in each cell is the maximum possible score for an alignment of any length ending at the coordinates of this specific cell, aligning this highest scoring segment will yield the highest scoring local alignment—the optimal local alignment. In one embodiment, matrices, gap penalties including gap initial costs and gap extension costs, E-value, etc are to be considered to get an optimal performance from a Smith-Waterman search.

The organization of the matrix of the algorithm is as follows: The lengths of the two sequences being compared using the Smith-Waterman algorithm are used as the row and column dimensions of the matrix. For example: A matrix H is built as follows:

H(i,0)=0, 0≧t≧m (Equation 1)

H(0,j)=0, 0≧j≧n (Equation 2)

if aᵢ=bⱼ w(aᵢ,bᵢ)=w(match) or if a_{i!=b}ⱼ w(aᵢ,bᵢ)=w(mismatch)

$$H ( i , j ) = max \{ \begin{matrix}0 & \\ H ( i - 1 , j - 1 ) + w ( {a}_{i} , {b}_{j} ) & \frac{Match}{Mismatch} \\ H ( i - 1 , j ) + w ( {a}_{i} , - ) & Deletion \\ H ( i , j - 1 ) \vert w ( - , {b}_{j} ) & Insertion\end{matrix} \} , \\ 1 \leq i \leq m , 1 \leq j \leq n \qquad ( Equation 3 )$$

Where:

a,b=Nucleotide or protein sequences;

m=length(a);

n=length(b);

H(i,j)—is the maximum Similarity-Score between a suffix of a[1 . . . i] and a suffix of b[1 . . . j]; and

w(c, d), c, d ∈ Σ ∪ {‘-’}, where ‘-’ is the gap-scoring scheme.

Additional data may be calculated for each of the reads. For example, a percent alignment may be calculated according to:

$$\frac{\# of Bases that Align}{\# of Total Bases In the Sequence} = \% Alignment . \qquad ( Equation 4 )$$

The percent alignment figure may be used to assess the relative quality of the read. In an embodiment, other data is also calculated. The other data includes, for example and without limitation, the overall number of single nucleotide polymorphisms (SNPs) in the read, the number of insertions or the number of deletions made in the read as compared to the reference sample sequence, and the number of aligned bases that are upstream and downstream of an insertion or deletion within the target site on the read, if applicable. The number of aligned bases that are upstream and downstream of an insertion or deletion within the target site on the read, over many reads, may indicate if the ZFN can reliably cut at a specific location.

The reads may be ranked or scored or filtered, and high quality alignments may be extracted, as illustrated in box 303. In an embodiment, one or more filters are used to separate high quality alignments from low quality alignments. For example, and without limitation, the percentage alignment value may be used to sort the reads. A user may choose a percentage alignment value, or the analysis system 507 may be provided with a percentage alignment value, to differentiate between high quality alignments and low quality alignments. For example, if a user chose a 95% alignment percentage as a criterion, the analysis system 507 discards reads that had an alignment percentage below 95%, and keeps reads that had an alignment percentage above 95%. Another filter may be the number of SNPs in the read. For example, a read with four or more SNPs may be rejected, or another number of SNPs may be used to accept or reject reads. Yet another filter may be the number of aligned bases that are upstream and/or downstream of the target site. For example, if less than two bases in a number of bases that are upstream and/or downstream of an insertion or deletion within the target site are aligned with the reference sample, the read may be rejected. In another embodiment, another number of aligned upstream or downstream bases is chosen. Yet another filter may be the number of insertions or deletions on a read. For example, if a read has two or more insertions or deletions as compared to the reference sample, the read may be rejected, or another number of insertions or deletions may be chosen. Yet another filter may be that the reads must have at least one insertion or deletion at the target site, since reads that have no insertions or deletions at the target site may not have been modified by the ZFN. In an embodiment, the reads that pass each of the filters that are defined may be high quality alignments.

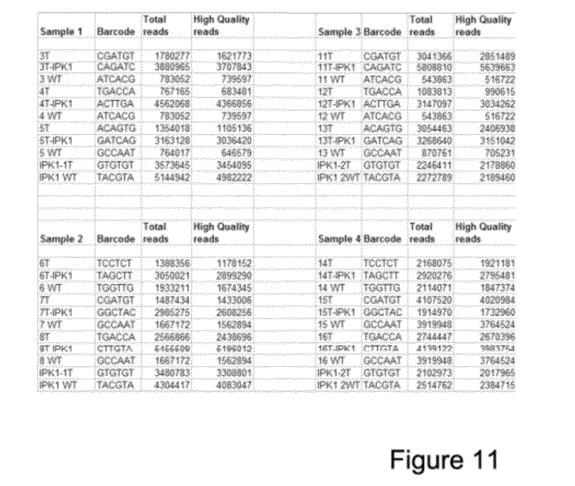

FIG. 11 shows an exemplary set of comparisons between total reads from the sequencer, and the number of high quality reads obtained after one or more quality score threshold filters were applied to the total reads. In the exemplary set of comparisons shown in FIG. 11, sequences within each barcode that contain any nucleotide with a quality score confidence interval less than 5, at any position within the sequence, are removed. Further, sequences within each barcode that contain an “N” at any location within the sequence, indicating that the one or more of the bases could not be read, are also removed. The sequences that pass these filters constitute the high quality sequences in this example.

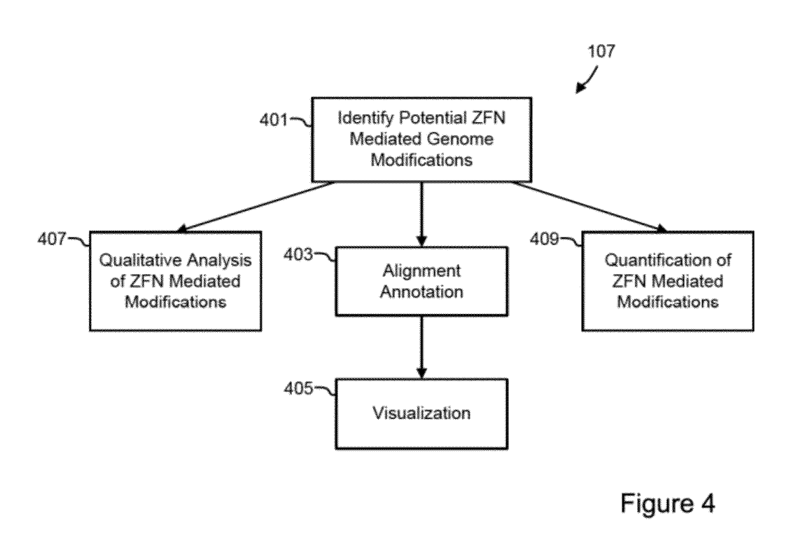

Turning now to FIG. 4, a flow chart showing the post-processing of data from FIG. 1 according to an embodiment of the present disclosure is shown. A potential ZFN mediated genome modifications are identified in each of the reads, as illustrated in box 401. In an embodiment, the process includes a qualitative analysis of ZFN mediated modifications, illustrated in box 407, whereby the percentage of sequences with insertions and deletions at each position of the reference sequence is compared for ZFN treated and control samples. The process may also include a quantitative analysis of the ZFN mediated modifications. The quantitative analysis may include computing the percentage of high quality reads that contain insertions or deletions at the target site. The equation that may be used in an embodiment for calculating the ZFN efficacy is:

$$\frac{\# of Insertions and \text{/} or Deletions}{\# of High Quality Sequences} \times 100 = Z F N Efficacy . \qquad ( Equation 5 )$$

The ZFN efficacy number, when compared to efficacy numbers for other ZFN proteins and the efficacy number for a control sample with no ZFN addition, provides a quantification of relative activities of different ZFN proteins at the active site, provided all ZFN proteins are expressed comparably.

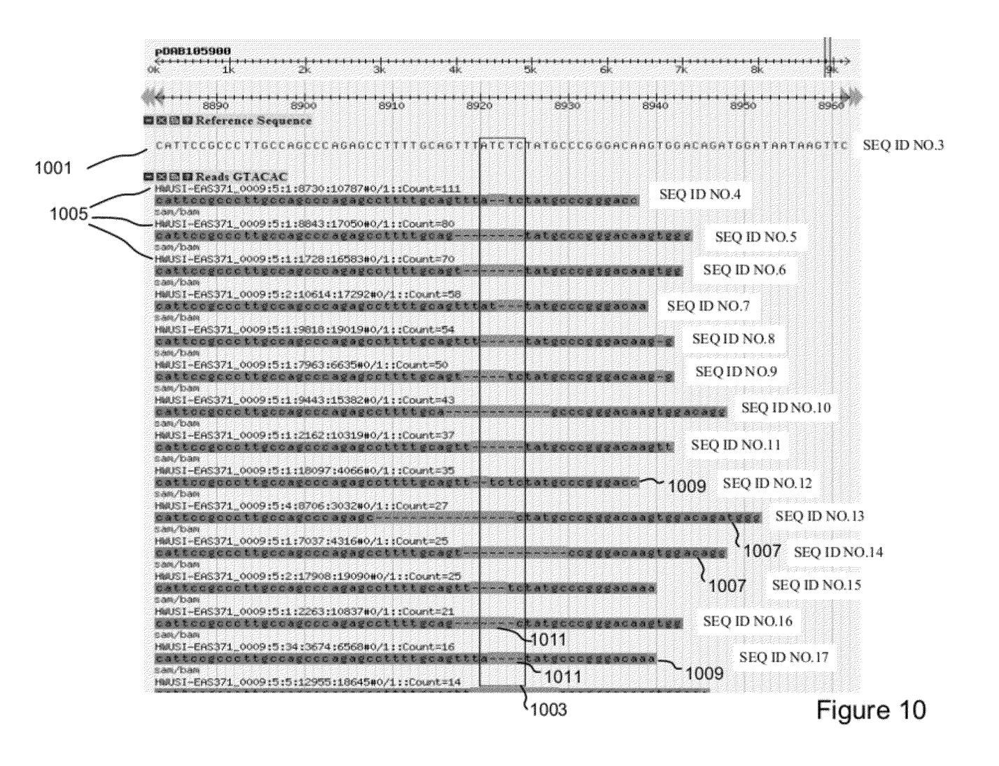

The alignments may be annotated, and the alignments may be input into visualization software and/or hardware, to visually inspect the modifications created by the ZFN at the target site, as illustrated in boxes 403 and 405. A user or the analysis system 507 may visualize the high quality reads using, for example and without limitation, Gbrowse or other genome viewer for annotating and/or interacting with sequences. An exemplary visualization is shown in FIG. 10. An exemplary visualization is shown in FIG. 10, showing several high quality sequences and their alignment against a reference sequence 1001. In this exemplary visualization, the target site of the ZFN in the reference sequence is represented by the nucleotides within box 1003. Each high quality sequence has been aligned against the corresponding nucleotides in the reference sequence 1001. A sequence header or ID 1005 is associated with each high quality sequence and is shown on top of the sequence. The ID 1005 contains the sequencer specific information about the sequence and a count that indicates the number of times this exact sequence occurred in the sequence dataset. In the visualization, an exact match of a nucleotide in the high quality sequence with the reference is indicated by a first visual characteristic, mismatched nucleotides are indicated by a second visual characteristic, and deletions are indicated by a third visual characteristic. In the illustrated alignment, an exact match of a nucleotide in the high quality sequence with the reference sequence is indicated by highlighting the nucleotide in a first color 1007, while mismatched nucleotides are indicated by highlighting the nucleotide in a second color 1009. Deletions with the high quality sequences are indicated as “-” 1011.

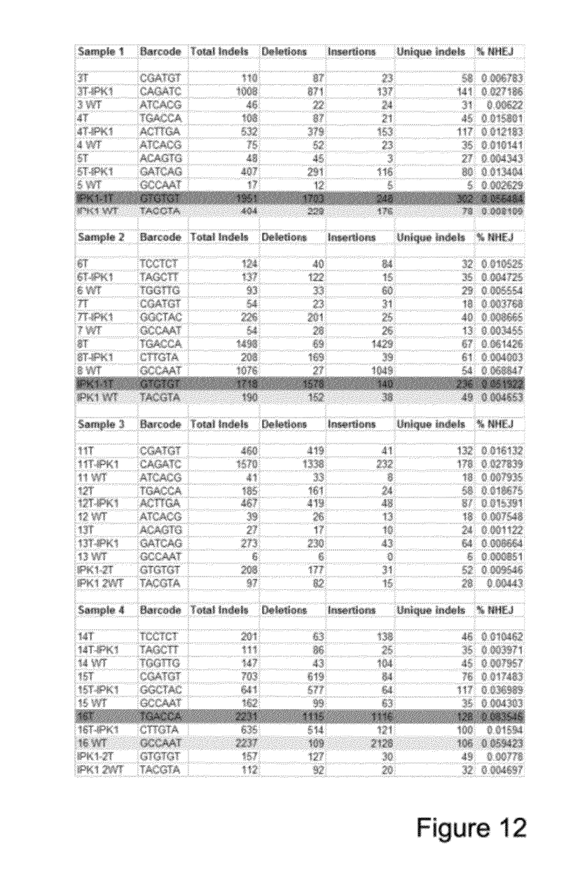

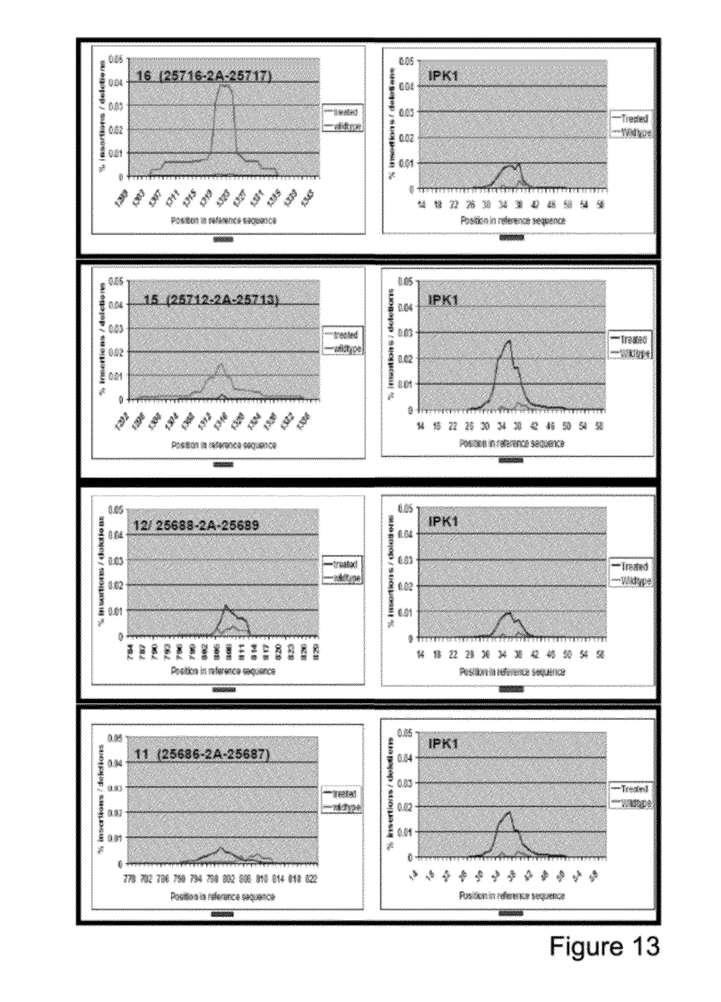

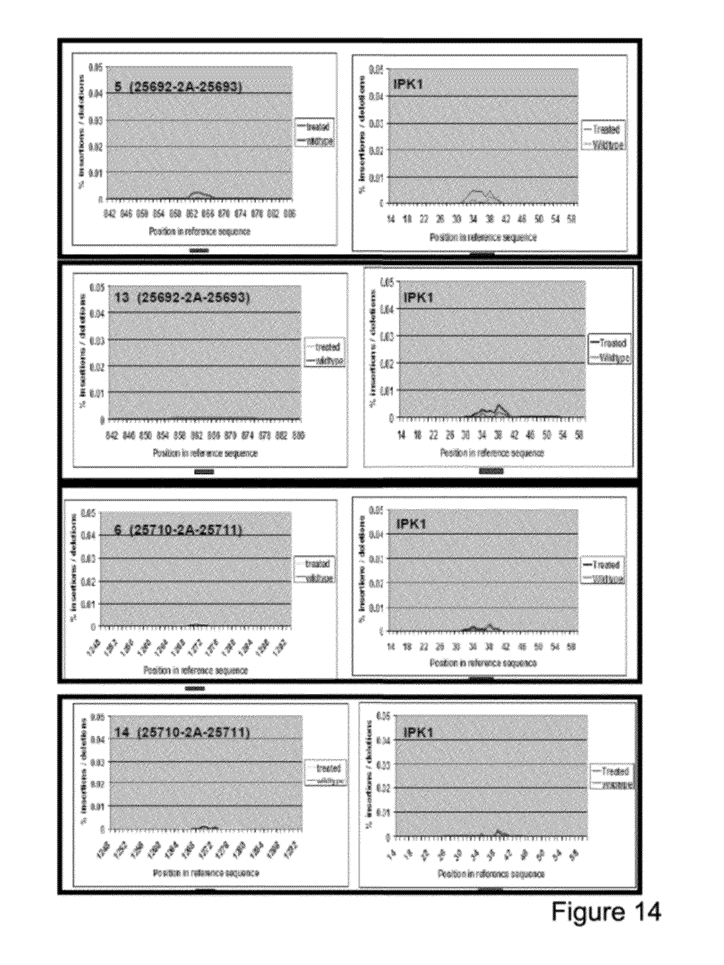

An exemplary quantitative analysis of several ZFNs is shown in FIG. 12. FIG. 13 and FIG. 14 show an exemplary set of graphs, detailing ZFN activity. The Y-axis of the graphs details the position in the reference sequence, and the X-axis of the graphs indicates the percentage of sequences that have insertions or deletions at the particular position in the reference sequence. A spike in the graph indicates high activity at a particular position. A particularly effective ZFN may have a high spike in the graph at the target site. Further, a particularly effective ZFN may have a distribution topology that is different from the distribution topology of the reference sample. In one example, the reference sample might have a distribution topology that contains a short peak at the beginning of the target site, while the distribution topology of the ZFN treated sample may be more spread out and may have a higher and wider peak that spans the target site. A particularly ineffective ZFN may have a graph that is indistinguishable from the graph of the reference sample. The activity distributions of different ZFNs can be further compared with the same scale on the Y-axis to identify the candidate with the highest activity. Using statistical tests, the difference in the distribution of the activity between the treated and the wild-type samples could then be used to distinguish effective and ineffective ZFNs.

An exemplary quantitative analysis of the activity of several candidate ZFNs is shown in FIG. 12. The first column of the figure indicates the IDs of samples treated with specific candidate ZFNs and the IDs of control samples to capture biological noise at the target genomic location in the plant system. The biological noise in the control samples comprises existing genomic variations at the target locations or genomic variations induced during the experimental procedure of extracting and sequencing the DNA from the plant sample. The second column indicates the 6 nucleotide barcode used to separate sequences based on the sample or experiment. The third column indicates the number of sequences, within all the high quality sequences, that contained an insertion or deletion at the target site. The fourth and fifth columns indicate the count of the subset of sequences in column 3 that contains deletions and insertions respectively. The sixth column indicates the number unique insertions or deletions among all the sequences indicated in column 3. The seventh column represents the ZFN activity, if a treated sample, or the level of noise, if a control sample, as the percentage of high quality sequences containing insertions or deletions, and is calculated using Equation 5. Comparing the ZFN activity of a particular ZFN treated sample to the level of biological noise in its corresponding control sample provides a quantitative measure of the efficiency of that particular ZFN at its target location in the genome. All the candidate ZFNs can further be ranked based on this measure.

In one exemplary embodiment, the sequencer provides data related to at least two million sequences. The analysis system 507 reduces the number of sequences to approximately 1.8 million, or approximately 5 percent of the initial sequences by identifying the high quality read sequences. Of the 1.8 million sequences, between 2000 and 5000 sequences are identified by the analysis system 507 as being unique. The analysis system 507 aligns the 2000 to 5000 sequences to the reference sequence, and calculates the high quality alignments. There may be between 100 and 500 high quality alignments. Therefore, the analysis system 507 has reduced the number of sequences, which include sequences treated with different ZFNs, by four orders of magnitude and by at least about 99.975 percent to up to 99.995 percent. In one embodiment, analysis system 507 has reduced the number of sequences by at least about 99 percent.

Turning now to FIG. 5, a flow chart of data and materials from a sequencer to a data analyzer according to an embodiment of the present disclosure is shown. One or more samples is prepared as illustrated in box 501. Each of the samples may contain many copies of a strand of DNA, and a quantity of a ZFN may be added to the samples. Each sample may have a different ZFN. As discussed herein the ZFN functions to cut the DNA strands at a target region. The DNA strands are then repaired. It is the ability of the ZFN to cut the DNA strands and the characteristics of the repair of the DNA strands that is being analyzed. In an embodiment, the samples are barcoded with a barcode that is unique to the sample and ZFN combination. A reference sample is also prepared, which contains the same DNA strand as was used for the samples, as shown in box 503. The samples treated with many different ZFNs, and the reference sample, are placed into a sequencer, shown in box 505. The sequencer may be, for example and without limitation, one or more sequencers, although any type of machine or process to provide an analysis of a sample may be used. The sequencer 505 determines the sequence of the DNA strand in the samples. In an embodiment, the sequencer 505 also performs additional calculations to determine, for example and without limitation, confidence intervals for each of the bases that the sequencer identifies. The sequencer 505 produces data. The data is in the form of, for example and without limitation, sequence information, or other calculations related to the sequence information, such as confidence intervals, and provided in text files or other data files.

The data from the sequencer is provided to the analysis system 507. The data may be provided by a network or a dedicated connection between the sequencer and the analysis system 507, or by a removable storage from the sequencer to the analysis system 507. In another embodiment, the sequencer prints the data to a screen or to a printer, and the data is input into the analysis system 507 from, for example and without limitation, a keyboard or a scanner. In one embodiment, the analysis system is a part of the sequencer.

The analysis system 507 receives the data from the sequencer, and calculates sequence information for high quality alignments, or other data related to the reads. In an embodiment, the analysis system 507 also provides calculated data to other analysis systems, to data storage systems, or to one or more visualization systems or visualization modules. In another embodiment, the analysis system 507 prints the data to a screen or to a printer, and the data is input into a visualization system or data storage system by, for example and without limitation, a keyboard or a scanner.

FIG. 6 shows a component view of the analysis system 507 of FIG. 5 according to an embodiment of the present disclosure. The analysis system 507 may include an input module 603, a calculation module 605, an output module 607, and a visualization module 611, which may reside in memory 615 of the analysis system 507. The modules may be executed by a controller 625 of analysis system 507. Controller 625 may be one or more processors. The memory 615 includes computer readable media. Computer-readable media may be any available media that may be accessed by one or more processors of the analysis system 507 and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by analysis system 507. The analysis system 507 may be a single system, or may be two or more systems in communication with each other. In one embodiment, the analysis system 507 includes one or more input devices, one or more output devices, one or more processors, and memory associated with the one or more processors. The memory associated with the one or more processors may include, but is not limited to, memory associated with the execution of the modules, and memory associated with the storage of data. In an embodiment, the analysis system 507 is associated with one or more networks, and communicates with one or more additional systems via the one or more networks. The modules may be implemented in hardware or software, or a combination of hardware and software. In an embodiment, the analysis system 507 also includes additional hardware and/or software to allow the analysis system 507 to access the input devices, the output devices, the processors, the memory, and the modules. The modules, or a combination of the modules, may be associated with a different processor and/or memory, for example on distinct systems, and the systems may be located separately from one another. In one embodiment, the modules are executed on the same system as one or more processes or services. The modules are operable to communicate with one another and to share information. Although the modules are described as separate and distinct from one another, the functions of two or more modules may instead be executed in the same process, or in the same system.

The input module 603 receives data from an input device 601. The input module 603 may also receive input over a network from another system. For example, and without limitation, the input module 603 receives one or more signals from a computer over one or more networks. The input module 603 receives data from the input device 601, and may rearrange or reprocess the data into a format recognizable by the calculation module 605, so that the data may be transmitted to the calculation module 605.

The input device 601 may communicate with the input module 603 via a dedicated connection or any other type of connection. For example, and without limitation, the input device 601 may be in communication with the input module 603 via a Universal Serial Bus (“USB”) connection, via a serial or parallel connection to the input module 603, or via an optical or radio link to the input module 603. The transmission may also occur via one or more physical objects. For example, the sequencer generates one or more files, and the sequencer or a user copies the one or more files to a removable storage device, such as a USB storage device or a hard drive, and a user may remove the removable storage device from the sequencer and attach it to the input module 603 of the analysis system 507. Any communications protocol may be used to communicate between the input device 601 and the input module 603. For example, and without limitation, a USB protocol or a Bluetooth protocol may be used.

In one embodiment, the input device 601 is a sequencer. The sequencer analyzes one or more samples and generates sequence data regarding the one or more samples. In an embodiment, the data is in the form of one or more files, or the sequencer may print the data to a screen or a printer, and the data is input into the analysis system 507 by, for example and without limitation, a keyboard, mouse, or scanner. In an embodiment, the sequencer also includes additional data describing the samples.

The network may include one or more of: a local area network, a wide area network, a radio network such as a radio network using an IEEE 802.11x communications protocol, a cable network, a fiber network or other optical network, a token ring network, or any other kind of packet-switched network may be used. The network may include the Internet, or may include any other type of public or private network. The use of the term “network” does not limit the network to a single style or type of network, or imply that one network is used. A combination of networks of any communications protocol or type may be used. For example, two or more packet-switched networks may be used, or a packet-switched network may be in communication with a radio network.

The calculation module 605 receives inputs from the input module 603, and performs one or more calculations based on the inputs. For example, and without limitation, the calculation module 605 separates the barcodes from the reads, applies one or more algorithms to extract the high quality read sequences from the other read sequences, and analyzes the reads to extract unique read sequences from the high quality read sequences. The calculation module 605 may also read the sequence information from the high quality read sequences, and attempt to align the sequences with one or more reference sample sequences. The alignment of the high quality read sequences with the reference sample sequence generates additional data, such as, for example, data regarding the number of modifications, or data regarding the number of insertions and/or deletions from the high quality read sequences to the reference sample sequence. In an embodiment, the calculation module 605, as described with respect to FIGS. 1-4, scores the high quality read sequences, and extracts high quality alignments from the high quality read sequences. The high quality alignments may be further analyzed, as shown above with respect to FIG. 4, so that data regarding the ZFNs is analyzed. Additionally, in an embodiment, the high quality alignments are analyzed and/or visualized.

The calculation module 605 provides as an output, for example, data regarding the high quality alignments, the read sequences for the high quality alignments, and/or data to be used by a visualization module to visualize one or more of the high quality alignments.

The visualization module 611 receives data as input from the calculation module regarding the sequence of one or more of the high quality alignments. The visualization module allows a user to visualize and/or manipulate the high quality alignments. In an embodiment, the visualization module 611 may use Gbrowse, or a modified version of Gbrowse. A user may have the ability to manipulate a visual representation of one or more of the high quality alignments. The visualization module allows the user to view the alignment of high quality sequences with genomic modifications against an original reference sequence. The visualization step allows a user to understand the activity of a ZFN, the background noise in the control sample, or the type or length or frequency of a particular genomic modification. This visualization is helpful for providing a recommendation on a ZFN nuclease as an active or inactive candidate. The visualization and subsequent translation of modified sequences provides a protein read-out of the modification. The read-out may be used in gene knockout applications. An example of gene knockout applications may include EXZACT™ Precision Technology brand mediated gene knockout applications, available from Dow AgroSciences.

The output module 607 receives an input, and transmits the input to an output device 609. In one embodiment, the output module 607 receives the input from the calculation module 605 in the form of alphanumeric data, and reformats the data to a format understandable to the output device 609, and transmits the data to the output device 609. The output module 607 and the output device 609 are in communication with one another. For example, and without limitation, the output module 607 and the output device 609 is in communication via a network, or is in communication via a dedicated connection, such as a cable or radio link. The output module 607 may also reformat the data received from the calculation module 605 into a format usable by the output device 609. For example, the output module 607 may create one or more files that may be read by the output device 609.

The output device 609 is, in an embodiment, a visualization system, another data analysis system 507, or a data storage system. The output module 607 communicates with the output device 609 by transmitting one or more electronic files to the output device 609. The transmission may occur over a dedicated link, for example a USB connection or a serial connection, or may occur over one or more network connections. The transmission may also occur via one or more physical objects. For example, the output module 607 may generate one or more files, and may copy the one or more files to a removable storage device, such as a USB storage device or a hard drive, and a user may remove the removable storage device from the analysis system 507 and attach it to the visualization system, another data analysis system, or the data storage system.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the present disclosure as come within known or customary practice in the art to which this disclosure pertains.

What is claimed is:

1. A method for analysis, comprising:
electronically receiving sequence data related to a plurality of sequences;
identifying a plurality of high quality read sequences from among the plurality of sequences;
extracting a plurality of unique read sequences from the plurality of high quality read sequences; and
comparing the plurality of unique read sequences against a reference sequence corresponding to a reference sample.

2. The method of claim 1, further comprising, after aligning the plurality of unique read sequences against the reference sequence data corresponding to the reference sample, calculating high quality alignments.

3. The method of claim 1, further comprising conducting a qualitative analysis of the aligned unique read sequences.

4. The method of claim 1, further comprising a quantitative analysis of the aligned unique read sequences.

5. The method of claim 1, further comprising visualizing the aligned unique read sequences.

6. The method of claim 1, further comprising calculating the alignment between each of the plurality of unique read sequences to the reference sequence.

7. The method of claim 1, further comprising electronically receiving confidence interval data related to the sequence data, the confidence interval data used at least in part to identify the plurality of high quality read sequences.

8. The method of claim 1, wherein each of the plurality of sequences describes at least a portion of a plant genome.

9. The method of claim 1, wherein barcode information describing one or more barcodes is electronically received associated with the sequence data.

10. The method of claim 1, wherein barcode information describing one or more barcodes is electronically received associated with the sequence data and associating the sequence data with one of at least two groups comprises reading the barcode information associated with the sequence data, and associating the sequence data according to the one or more barcodes.

11. The method of claim 1, further comprising the step of associating the sequence data with one of at least two groups.

12. A system for analysis, comprising:
a module for receiving sequence data related to a plurality of sequences; and
a calculation module, wherein the calculation module is operable to:
identify a plurality of high quality read sequences from among the plurality of sequences;
extract a plurality of unique read sequences from the plurality of high quality read sequences; and
compare the plurality of unique read sequences relative to a reference sequence corresponding to a reference sample.

13. The system of claim 12, wherein the calculation module is further operable to calculate high quality alignments from the plurality of high quality read sequences.

14. The system of claim 12, further comprising a module to conduct a qualitative analysis of the aligned unique read sequences.

15. The system of claim 12, further comprising a module to conduct a quantitative analysis of the aligned unique read sequences.

16. The system of claim 12, further comprising a module to visualize the aligned unique read sequences.

17. The system of claim 12, wherein the calculation module is further operable to calculate the alignment between each of the plurality of high quality alignments to the reference sequence.

18. The system of claim 12, wherein the calculation module further associates the sequence data with one of at least two groups.

19. A method for analysis, comprising:
electronically receiving sequence data regarding a plurality of sequences, the plurality of sequences describing at least a portion of a plant genome, the plurality of sequences having been previously exposed to one or more zinc finger nucleases to cut the sequences;
electronically receiving confidence interval data related to the sequence data;
identifying a plurality of high quality read sequences from among the plurality of sequences based at least in part on the confidence interval data;
extracting unique read sequences from the one or more high quality read sequences; and
aligning the unique read sequences against sequence data corresponding to the reference sample.

20. The method of claim 20, further comprising the steps of:
electronically receiving barcode information associated with the sequence data; and
associating the sequence data with one of at least two groups based at least in part on the barcode information.

21. A method for analysis, comprising:
electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and
electronically determining, based in part on a reference sequence, a second number of sequences which is a subgroup of the first number of sequences, the second number of sequences being selected based on the ZFN used to cut the sequence and at least one characteristic of repair to the sequence, the second number of sequences being at least two orders of magnitude less than the first number of sequences.

22. The method of claim 21, wherein the second number of sequences is at least four orders of magnitude less than the first number of sequences.

23. The method of claim 21, wherein a first characteristic of repair to the sequence includes a measure of at least one of a number of insertions in a target cut region and a number of deletions.

24. The method of claim 21, wherein the step of electronically determining, based in part on the reference sequence, the second number of sequences includes the steps of:
separating the first number of sequences into a plurality of groups based on the ZFN used to cut the respective sequence,
identifying a plurality of high quality read sequences in the first number of sequences, the plurality of high quality read sequences having a third number of sequences which is less than the first number of sequences and greater than the second number of sequences,
identifying a plurality of unique read sequences from the third number of sequences, the plurality of unique read sequences having a fourth number of sequences which is less than the third number of sequences and greater or lesser than the second number of sequences, and
comparing each of the fourth number of sequences relative to the reference sequence to identify a plurality of high quality alignment sequences.

25. A method for analysis, comprising:
electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and
electronically determining, based in part on a reference sequence, a second number of sequences which is a subgroup of the first number of sequences, the second number of sequences being selected based on the ZFN used to cut the sequence and at least one characteristic of repair to the sequence, the second number of sequences being less than 1 percent of the first number of sequences.

26. The method of claim 25, wherein the second number of sequences is less than 0.1 percent of the first number of sequences.

27. The method of claim 25, wherein the second number of sequences is less than 0.01 percent of the first number of sequences.

28. The method of claim 25, wherein the second number of sequences is less than 0.01 percent of the first number of sequences and the first number of sequences is at least one million sequences.

29. The method of claim 25, wherein a first characteristic of repair to the sequence includes a measure of at least one of a number of insertions in a target cut region and a number of deletions.

30. A method for analysis, comprising:
electronically receiving sequence data related to a first number of sequences, the first number of sequences including a plurality of sequences having been cut by a plurality of zinc finger nucleases (ZFNs) and subsequently repaired, a first portion of the first number of sequences having been cut by a first ZFN and subsequently repaired and a second portion of the first number of sequences having been cut by a second ZFN and subsequently repaired; and
electronically determining, based in part on the reference sequence, a second number of sequences which is a subgroup of the first number of sequences, the second number of sequences being selected based on the ZFN used to cut the sequence and at least one characteristic of repair to the sequence, the second number of sequences being less than 1 percent of the first number of sequences, wherein the step of electronically determining, based in part on a reference sequence, the second number of sequences includes the steps of:
separating the first number of sequences into a plurality of groups based on the ZFN used to cut the respective sequence;
identifying a plurality of high quality read sequences in the first number of sequences, the plurality of high quality read sequences having a third number of sequences which is less than the first number of sequences and greater than the second number of sequences,
identifying a plurality of unique read sequences from the third number of sequences, the plurality of unique read sequences having a fourth number of sequences which is less than the third number of sequences and greater or lesser than the second number of sequences, and
comparing each of the fourth number of sequences relative to the reference sequence to identify a plurality of high quality alignment sequences.
